(19) United States
(12) Patent Application Publication
(10) Pub. No.: US 2007/0090168 A1
(43) Pub. Date: Apr. 26, 2007

(54) Protective coating and coated welding tip and nozzle assembly

(76) Inventors: Gerald F. Snow, Almont, MI (US); Charles M. Stempien, Wolverine Lake, MI (US)

Correspondence Address: WINSTON & STRAWN LLP;PATENT DEPARTMENT, 1700 K STREET, N.W., WASHINGTON, DC, 20006, US

(21) Appl. No.: 11/588,201

(22) Filed: Oct. 25, 2006

Related U.S. Application Data
(63) Continuation-in-part of application No. 11/258,424, filed on Oct. 25, 2005, now abandoned.

(51) Int. Cl. A47J 36/02

(52) U.S. Cl. 228/101

(57) ABSTRACT

A coated welding tip and nozzle assembly is disclosed. The tip and the nozzle are coated with a coating composition comprising titanium dioxide. The coating provides resistance to adhesion and accumulation of weld spatter on the nozzle and tip and facilitates weld spatter removal. The coating also protects against thermal damage of the nozzle by providing a thermal barrier.

### CROSS-REFERENCE TO RELATED APPLICATIONS

This is a continuation-in-part of U.S. application Ser. No. 11/258,424, filed Oct. 25, 2005, the entire content of which is hereby incorporated by reference thereto.

### FIELD OF THE INVENTION

The invention relates generally to welding equipment and, more specifically, to a welding tip and nozzle assembly for a welding gun.

### BACKGROUND OF THE INVENTION

Welding is a fabrication process that joins materials, usually metals or thermoplastics, by causing melting and coalescence. One of the various welding processes is arc welding, which uses a welding power supply to create and maintain an electric arc between an electrode and the base material to melt metal at the welding point. Common types of arc welding include shielded metal arc welding, also known as stick welding, which strikes an arc between the base material and consumable steel electrode rod that is covered with a CO₂ flux that protects the welding area from oxidation and contamination; tungsten inert gas (TIG) welding, which uses a nonconsumable electrode made of tungsten, an inert or semi-inert gas mixture, and a separate filler material; and metal inert gas (MIG) welding, also known as gas metal arc welding, which is a semi-automatic or automatic welding process that uses a continuous feed of welding wire as an electrode and an inert or semi-inert gas mixture to protect the weld from contamination.

One of the disadvantages associated with welding of metal is that the process generates substantial weld spatter, which is made up of elements found in both the workpiece that is being welded and the welding electrode or wire, such as, for example, iron, aluminum, and silicon. Weld spatter is metal that is spattered by extreme heat of the arc, which causes the molten metal to boil so that droplets of molten or liquid metal are sprayed from the arc. When a nozzle is used, such as in MIG or TIG welding processes, the liquid or molten metal over time builds up on the nozzle and tip during continuous use, and longer welding times result in a larger buildup of weld spatter deposits. In addition to high welding temperatures, factors such as improper amperage setting, wire feed rate, and the type of the substrate being welded cause weld spatter.

Weld spatter adheres to the workpiece and various parts of the welding gun, including the tip and nozzle, thus affecting the quality of the weld by obstructing the nozzle and the longevity and performance of the welding gun by causing rapid deterioration of the tip and nozzle. This is especially true in MIG welding, in which the electrode wire and gas are supplied directly through the tip and the nozzle of the welding gun.

Accumulation of weld spatter on the welding tip increases friction and reduces electrical contact with the welding wire, thereby slowing welding operation. Further, deterioration of the welding tip from accumulation of weld splatter causes the arc to extend into the nozzle, resulting in “burn back,” which can interrupt operation by fusing the electrode wire with the tip, and requiring premature tip replacement. Likewise, accumulation of weld spatter on the nozzle restricts the flow of the gas to the weld and requires frequent replacement of the nozzle, as an insufficient flow of gas will produce a flawed weld and may render the workpiece unusable.

When using a traditional welding tip and nozzle assembly, weld spatter must be removed from the welding gun at frequent intervals to ensure proper weld formation. Depending on the welding process and the type of material and equipment used, the traditional welding tip and nozzle assembly requires removal of weld spatter as frequently as after about three welding operations, i.e., after forming about three welds. Removal of spatter, however, slows the welding process and reduces the efficiency of the process, as it requires grasping and separating the spatter from the nozzle with pliers or reaming the nozzle. Furthermore, reaming or scoring used in robotic operations is a highly abrasive process that can scratch or damage the nozzle, and damage from reaming compromises the performance of the nozzle.

Thus, attempts have been made to reduce spatter accumulation on components of the welding gun. U.S. Pat. No. 3,536,888 discloses a tube fitted inside the nozzle formed of porcelain, alumina, beryllia, zirconium silicate, zirconia, magnesium aluminum silicate, cordierite, mullite, ceramic graphite, or boron nitride. When the tube is made of ceramic, it may be coated with a silicate or silicone material. U.S. Pat. No. 4,450,341 discloses a contact tip with a copper body and a wear-resistant member which may be formed of tool steel, metallic carbide alloys, or a ceramic composition. U.S. Pat. No. 5,796,070 discloses a shield that fits within the nozzle, the shield being made of a ceramic coated aluminum, anodized aluminum, or porous ceramic.

Various patents disclose applying a coating on certain parts of a welding gun. U.S. Pat. No. 3,237,648 discloses coating the contact tube with silicon nitride. U.S. Pat. No. 3,430,837 discloses coating the tip and the inside of the nozzle with an anti-stick coating comprising either TEFLON®, a high temperature ceramic, or pyrolytic graphite. U.S. Pat. No. 3,659,076 discloses a nozzle coated on the exterior surface with a hard anodic coating of aluminum to provide electrical insulation, a coated electrically insulating sleeve, and a weld spatter guard disc fixed to the contact tip. U.S. Pat. No. 4,575,612 discloses a guide tube for an arc welding machine, the interior surface of which is provided with a protective layer of alumina or chromium dioxide, and a nozzle, whose the inside and outside surfaces are covered with ceramics. U.S. Pat. No. 4,672,163 discloses a nozzle formed of a heat-resistant non-conductive material such as silicon nitride, silicon nitride ceramic, or SIALON™ ceramic. When the nozzle is made of metal, a ceramic layer can be provided on the inner and outer surfaces of the nozzle. U.S. Pat. No. 4,861,392 discloses a welding aid including a particulate carbon-based weld spatter adhesion inhibitor and a particulate calcium-based adjuvant mixed with the inhibitor, wherein the mixture is capable of being applied to a metal surface. U.S. Pat. No. 4,947,024 discloses coating the contact tip or the nozzle with a film of tungsten disulfide or another low friction material having a good electrical conductivity, including a sulfide, selenide, silicide, boride, nitride, or carbide of titanium, zirconium, tungsten, tantalum, vanadium, chromium, or hafnium. U.S. Pat. No. 5,034,593 discloses a nozzle made from graphite or ceramic fiber composites and coated with silicon nitride, SIALON™, boron nitride, or silicon carbide. U.S. Pat. No. 5,278,392 discloses a nozzle body formed of a porous polycrystalline graphite material and surrounded by a copper jacket. The contact tip may be covered with the same graphite material, impregnated with petrolatum and wax. U.S. Pat. No. 5,628,924 discloses a plasma arc torch, wherein a gold or silver metallic layer is provided on the surface of the electrode holder and/or a surface of the nozzle. The electrode holder and/or the nozzle can also be formed of aluminum or an aluminum alloy, and an anodic oxide film can be formed on the surface thereof. U.S. Pat. No. 6,811,821 discloses coating with a slurry comprising a mineral material in water to prevent weld spatter adhesion.

Existing inserts and coatings do not sufficiently prevent spatter accumulation along the surfaces of welding tip and nozzle located adjacent the weld during the welding process, and still equire extensive treatment and reaming of the nozzle after a few welding operations to remove spatter. For example, ceramic coatings typically accumulate substantial weld spatter only after several welding operations and must be cleaned frequently, especially in MIG welding. In nozzles that direct gas towards the welding site, the accumulated spatter reduces and disturbs the gas flow through a welding nozzle, and thus decreases the quality of the weld. In addition, existing coatings fail to withstand extremely high temperatures of molten metal spatter as well as the heat associated with performing shielded arc welding in a confined space having limited heat dissipating capability, resulting in damage to the coating, such as melting, burning, peeling, flaking, and bubbling, and to the nozzle, such as burning, discoloration, and distortion of the metal.

Accordingly, there is a need for an improved welding device that reduces adhesion and accumulation of weld spatter and protects the device against thermal damage. There is also a need for a welding device that facilitates the removal of weld spatter.

### SUMMARY OF THE INVENTION

The invention provides a coating that protects an article that is to be exposed to a high level of heat, such as articles used directly adjacent a heat source, from thermal adhesion and thermal damage.

In one embodiment, the invention relates to a welding aid for use with a high-temperature exposure article configured for exposure to a predetermined temperature. The welding aid comprises a particulate titanium dioxide weld spatter adhesion inhibitor and a liquid carrier for the adhesion inhibitor. The mixture is capable of being applied as a coating upon a surface of the article to form a thermal barrier that inhibits adhesion of weld spatter to the article. The welding aid can further comprise a cross-linking polymer in an amount sufficient to provide cross-linking during formation of the thermal barrier. A particulate fluorocarbon adjuvant, such as polytetrafluoroethylene, can also be included. A high-temperature exposure article is protected from adhesion of weld spatter by applying the welding aid as a coating upon at least a portion of a surface of the article prior to welding. The invention also provides improved longevity of a welding nozzle by applying the welding aid as a coating upon at least a portion of a surface of the nozzle susceptible to receiving weld spatter to form a thermal barrier thereon to reduce the adherence of weld spatter thereto.

The invention also relates to a coated welding assembly, comprising a nozzle assembly and a thermal barrier provided upon at least a portion of a surface of the nozzle, the thermal barrier comprising a titanium dioxide weld spatter adhesion inhibitor so that the thermal barrier inhibits adhesion of weld spatter to the nozzle assembly. The nozzle assembly can comprise a gas nozzle. The nozzle assembly can also comprise a tip portion for connecting to a welding gun and for feeding a rod of welding material to a workpiece, wherein the thermal barrier is provided upon the tip to reduce accumulation of weld spatter on the tip. The thermal barrier on the coated welding assembly provides resistance to adhesion and accumulation of weld spatter for at least 5, 10, or 15 hours of continuous welding operation, such that at least 10% or 50% of the spatter adhered to the coating is removable by tapping by hand.

The invention also relates to a method for preparing the coated welding assembly. The method comprises preparing a liquid coating composition comprising, by weight of the liquid composition, about 15 to 70% of a solvent, about 10 to 50% of an alkyd resin, about 1 to 15% of a cross-linking agent, and about 1 to 30% of titanium dioxide; dipping a portion of the nozzle assembly into the composition to form a coating thereon; and drying and curing the composition to form the thermal barrier on that portion of the nozzle assembly.

The invention also relates to a welding nozzle for a welding gun, such as a copper nozzle, at least a portion of the interior and exterior surfaces of the nozzle having a thermal barrier disposed thereon, wherein the thermal barrier comprises a titanium dioxide weld spatter adhesion inhibitor so that the thermal barrier inhibits adhesion of weld spatter to the nozzle. Weld spatter adhered to the welding nozzle can be removed by exerting an impact force sufficient to dislodge the weld spatter from the nozzle. Further, the nozzle can be recoated after removing weld spatter.

Thus, the invention provides a thermal barrier to resist or reduce accumulation of weld spatter and to prevent the spatter from firmly adhering to parts of welding equipment coated with the thermal barrier. This allows the maintenance of gas flow at an acceptable level while reducing the amount of disturbance of the flow and incidents of burn back. Productivity and efficiency of the welding process, as well as the longevity of the welding equipment, can thus be increased, allowing more efficient and cost-effective welding production.

### BRIEF DESCRIPTION OF THE DRAWINGS

FIG. 1 is a perspective view of a welding gun having a coated welding tip and nozzle assembly according to the invention;

FIG. 2 is a fragmentary elevated view of the coated welding tip and nozzle assembly of FIG. 1; and

FIG. 3 is an exploded perspective view of the coated welding tip and nozzle assembly of FIG. 1.

### DESCRIPTION OF THE PREFERRED EMBODIMENTS

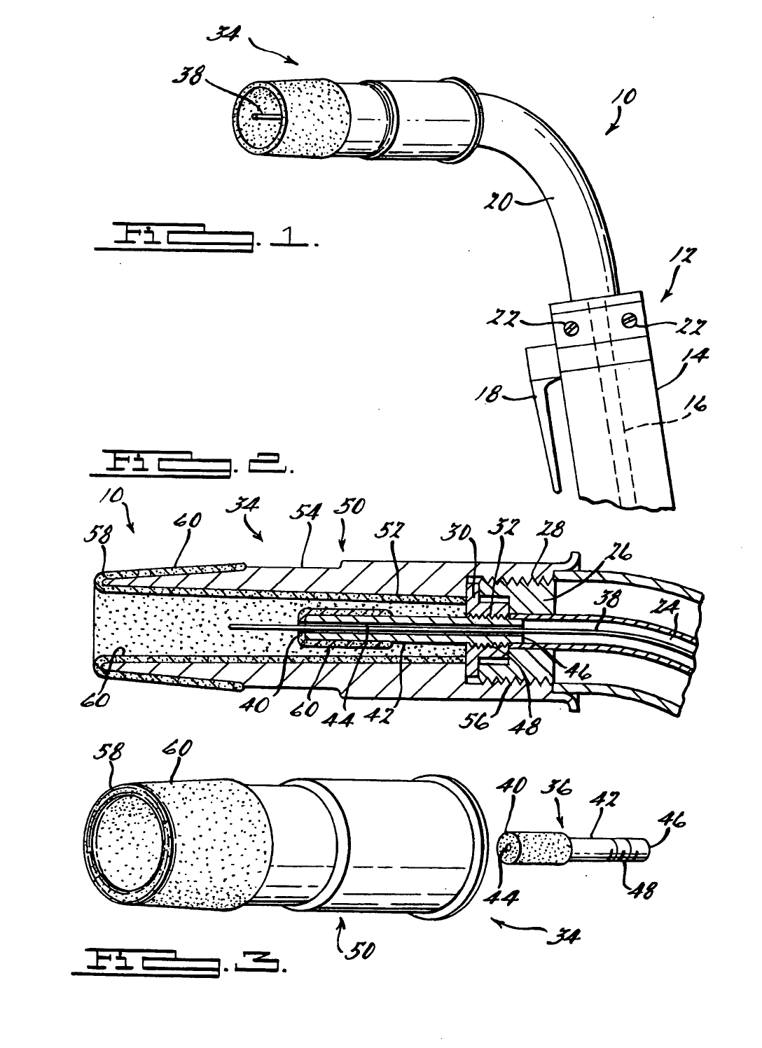

Referring to FIG. 1, the welding gun 10 is exemplary of a welding gun for use in connection with a MIG welding system, which is not shown but generally known in the art.

Components of a MIG welding system include a power source/wire feeder, a gas source/tank containing a gas that is operatively attached to the power source/wire feeder, a source/spool of welding wire that is also operatively attached to the power source/wire feeder, a welding/lead cable, a work clamp, and a return cable that is operatively attached between the work clamp and the power source/wire feeder. While the welding gun 10 shown in FIG. 1 is illustrated for use in connection with a MIG welding system, it will be appreciated that the welding gun according to the invention can be employed in connection with a variety of welding systems, for example, TIG, a stick electrode, and oxyacetylene welding systems. It will also be appreciated that the term “welding wire,” as used herein, includes a variety of wires used in welding systems, including an electrode wire and a wire made of the welding material.

Referring to FIG. 1, the welding gun 10 includes a handle, generally indicated at 12, which enables a user to orient the welding gun 10 relative to a workpiece (not shown). The handle 12 includes a body 14. The body 14 is generally cylindrical in shape. The body 14 includes a passage 16 defined therein. The passage 16 is adapted to receive welding materials, i.e., welding wire and gas, from a lead wire (not shown). It should be appreciated that the body 14 can include other configurations for a particular welding application or ergonomic function, for example, an hourglass or teardrop configuration.

The handle 12 also includes an actuating mechanism 18. The actuating mechanism 18 controls the rate at which welding materials are directed through the passage 16. As illustrated in FIG. 1, the actuating mechanism 18 is a trigger. The trigger 18 is mounted to the handle 12 of the welding gun 10, which is representative of a hand-held welding gun assembly, wherein the welding wire 38 is manually actuated toward a workpiece as shown in FIG. 2. It should be appreciated that the actuating mechanism 18 can include different structures adapted to accomplish the same end, for example, a button or toggle, and can further include a releasable locking member. It should also be appreciated that the invention can be employed in connection with a welding gun having a remotely located actuating mechanism, such as stationary or automated welding guns.

Referring to FIGS. 1 and 2, the welding gun 10 further includes a neck 20 operatively attached to the handle 12. As illustrated in FIG. 1, the neck 20 is operatively attached to the handle 12 by fasteners 22 such as screws. As illustrated in FIG. 2, the neck 20 includes an internal cavity 24 that cooperates with the passage 16 to deliver welding materials to the welding tip and nozzle assembly. The neck 20 is attached to the handle 12 in any suitable manner, for example, by a nut or quick connection. While the neck 20 is shown in an arcuate configuration in FIG. 1, the neck 20 can have any suitable configuration, such as a straight configuration. The neck 20 further includes a receiving end 26 having an outer portion 28. In the embodiment shown, the outer portion 28 of the receiving end 26 is threaded for receiving other components of the welding gun 10. The outer portion 28 of the receiving end 26 can include other structure that accomplishes a similar end, for example, a spring-loaded locking mechanism or quick connection.

The neck 20 further includes an adapter 30 to operatively engage other components of the welding gun 10. In the embodiment illustrated in FIG. 2, the adapter 30 includes a threaded aperture 32 to receive a tip portion of a welding nozzle and tip assembly. It should be appreciated that the welding gun 10 includes an insulator (not shown) to prevent electricity in the welding wire from flowing through the neck 20 and short-circuiting the welding system. It should also be appreciated that the welding gun 10 includes a diffuser (not shown) to regulate the flow of gas from the neck 20. Where the receiving end 26 provides the necessary diffusing characteristics, the adapter 30 is an insulator. Where the receiving end 26 provides the necessary insulating characteristics, the adapter 30 is a diffuser.

Referring to FIGS. 2 and 3, the welding gun 10 further includes a coated welding tip and nozzle assembly 34, which is operatively attached to the neck 20. The coated welding tip and nozzle assembly 34 includes a tip, generally indicated at 36. The tip 36 is adapted to dispense an elongate welding wire 38. The tip 36 includes a terminal end 40 and a shank 42 extending from the terminal end 40. The shank 42 includes a conduit 44 adapted to facilitate delivery of the elongate welding material 38 to the terminal end 40. As illustrated in FIG. 2, the elongate welding material 38 is a welding wire. The tip 36 further includes a connecting end 46, opposite the terminal end 40, having a threaded section 48 to provide attachment to the threaded aperture 32 of the adapter 30 in a screw-like manner. When the adapter 30 includes a different manner of attachment, the connecting end 46 of the tip 36 will include a corresponding section for proper attachment. When the tip and nozzle assembly 34 are employed in a stick welding process, the elongate welding wire is an electrode stick.

The welding tip and nozzle assembly 34 also includes a nozzle, generally indicated at 50. The nozzle 50 is operatively attached to the receiving end 26 of the neck 20 and adapted to substantially surround the tip 36. The nozzle 50 includes an interior surface 52 adjacent the tip 36 and an exterior surface 54 opposite the interior surface 52. More specifically, the interior surface 52 of the nozzle 50 includes a threaded engaging section 56, which corresponds to the threaded outer portion 28 of the receiving end 26 to attach the nozzle 50 to the neck 20 in a screw-like manner. When the receiving end 26 includes a different manner of attachment on the outer portion 28, the interior surface 52 of the nozzle 50 will include a corresponding engaging section 56 for proper attachment.

The nozzle 50 further includes a distal end 58 opposite the threaded engaging section 56. As illustrated, the nozzle 50 has a tapered profile toward the distal end 58. As illustrated in FIG. 2, the exterior surface 54 of the nozzle 50 tapers inwardly toward the distal end 58. While a tapered profile is shown, the nozzle can have a different profile, for example, a straight profile or a profile that expands outwardly toward the distal end 58. The nozzle 50 can also include an interior surface 52 that is straight, tapers toward the distal end 58, or expands outwardly toward the distal end 58.

Generally, MIG welding is performed by completing an electrical circuit between the power source/wire feeder and the workpiece. Welding materials, i.e. welding rod and gas, are dispensed from a power source/wire feeder to the welding gun 10 through a lead cable. A work clamp is attached to the workpiece and a return line is attached between a work clamp and a power source/wire feeder. The electrical circuit between a power source/wire feeder and a workpiece is completed when the trigger is actuated and the wire touches the workpiece, producing an arc. The electric arc produces heat that melts the workpiece in a region surrounding the point of contact between the wire and the workpiece. The wire also acts as filler material to join the workpiece. The inert gas forms a shield that prevents chemical reactions from occurring at the weld site, since such reactions can compromise the structural integrity of the weld. When the arc is removed, the molten material solidifies and forms a weld. During the welding process, however, the melting workpiece and wire “puddle” along the weld and often spatter onto the workpiece as well as the welding gun.

The coated welding tip and nozzle assembly according to the invention includes a coating 60 of thermal barrier disposed on the exterior surface of the tip 36 and/or exterior 54 and/or interior surfaces 52 of the nozzle 50, to prevent or reduce accumulation of weld spatter. Preferably, the coating is applied on the tip 36 as well as both the exterior and interior surfaces of the nozzle 50 for maximum protection against weld spatter.

According to the embodiment shown in FIGS. 2 and 3, the coating 60 is disposed on the entire interior surface 52 of the nozzle 50 and over a predetermined portion of the exterior surface 54, preferably including the front perimeter along the opening of the nozzle. While the coating 60 is applied to a predetermined portion of the exterior surface 54 where weld spatter accumulation is most likely, the coating 60 can be applied to the entire exterior surface 54. The portion of the exterior surface 54 receiving the coating can be adjusted as desired. Similarly, the portion of the exterior surface of the tip 36 receiving the coating can be adjusted as desired. Because the presence of the coating on the inner diameter of the tip 36 can increase friction with the welding wire, application of the coating on the inner diameter is preferably avoided. This can be achieved by any suitable means, for example, by plugging the opening or conduit 44 of the tip during coating application.

The preferred coating 60 includes a heat-resisting agent or a thermal adhesion inhibitor. The term “heat-resisting agent,” as used herein, includes a material that is capable of preventing or reducing thermal damage and/or thermal adhesion caused by high temperatures. Thermal damage includes burning, melting, metal discoloration, metal distortion, and other damages caused by heat. The term “thermal adhesion,” as used herein, includes adhesion of material caused by heat, for example, by being sprayed or otherwise deposited onto a surface in a form that is capable of adhering to the surface, e.g., molten or liquid form. An example of thermal adhesion is weld spatter adhesion. The preferred thermal adhesion inhibitor is titanium dioxide, used alone or in a mixture with another agent that provides heat resistance or prevents thermal adhesion. Any suitable form of titanium dioxide can be used, including the particulate form.

According to an embodiment, the coating comprises titanium dioxide in an amount at least about 1%, preferably at least about 3%, more preferably at least about 5%, and most preferably at least about 7%, by weight of the wet coating. The coating comprises titanium dioxide in an amount at most about 40%, preferably at most about 30%, more preferably at most about 20%, and most preferably at most about 15%, by weight of the wet coating. By weight of the dried coating, the coating comprises titanium dioxide in an amount at least about 1%, preferably at least about 3%, more preferably at least about 7%, and most preferably at least about 10%. The coating comprises titanium dioxide in an amount at most about 45%, preferably at most about 35%, more preferably at most about 25%, and most preferably at most about 15%, by weight of the dried coating.

The titanium dioxide is preferably provided in an amount to impart anti-stick or anti-thermal adhesion characteristics to significantly reduce adhesion of spatter to the coated portions of the nozzle such that at least 30%, more preferably at least 50%, more preferably at least 80%, more preferably at least 90%, and most preferably substantially all of the spatter is removed by tapping or pulling by hand or with pliers. The remaining spatter can be removed by a scraping or cutting procedure, such as filing or reaming.

Also, the amount of the titanium dioxide is preferably sufficient to reduce or substantially prevent spatter, or preferably the above percentages of spatter, from coalescing on the coated portions of the tip and nozzle assembly. The amount of weld spatter accumulated on a nozzle coated with a coating prepared according to the invention is about 50% or less, preferably about 30% or less, more preferably about 20% or less, and most preferably about 5% or less, by weight, of the amount of weld spatter that would accumulate on a conventional uncoated nozzle of the similar underlying metal, after welding operation under the same conditions and for the same duration. Preferably, the coating allows at least up to 50, more preferably at least up to 100 or 200 continuous welding operations without interruption for cleaning of the tip and nozzle assembly to remove accumulated weld spatter.

Titanium dioxide advantageously provides high heat resistance and tolerance, while preventing thermal adhesion and facilitating removal of weld spatter from the coating. Thus, a highly effective thermal barrier is achieved by providing a coating of titanium dioxide. Titanium dioxide also fuctions as a white pigment in the coating.

Preferably, the coating additionally includes a cross-linking polymer. The polymer is any suitable cross-linking polymer, and is included in an amount sufficient to provide adhesion to the surface to be coated, e.g., portions of a welding nozzle assembly, which are typically made of metals such as copper, nickel, and brass. In an embodiment, the cross-linking polymer is a polymer formed from an alkyd resin. In a further embodiment, the coating comprises titanium dioxide and a polymer formed from an alkyd resin. Optionally, a prepolymer resin can also be included in an amount sufficient to effect cross-linking of the alkyd resin. A non-prepolymer cross-linking agent, e.g., an acid, can also be used. In an embodiment, the coating comprises a polymer formed from an alkyd resin, optionally with a synthetic prepolymer resin, in an amount of about 20 to 60%, more preferably about 30 to 50%, by weight of the wet coating.

In an example, the coating comprises, by weight of the dried coating, an alkyd resin polymer in an amount of about 20 to 60% and titanium dioxide in an amount of about 1 to 30%. In another example, the coating comprises, by weight of the dried coating, an alkyd resin polymer in an amount of about 30 to 50% and titanium dioxide in an amount of about 5 to 15%.

If desired, the coating can additionally include a fluorocarbon. The fluorocarbon provides additional anti-stick characteristics to the coating. Any suitable form of fluorocarbon, e.g., particulate form, can be used. For example, the fluorocarbon is provided as a particulate adjuvant and mixed with the thermal adhesion inhibitor in the coating. Examples of suitable fluorocarbons include fluorinated ethylene, e.g., polytetrafluoroethylene (PTFE), and fluorinated ethylene propylene copolymer. Preferably, a coating containing a fluorocarbon is used in environment that is not conducive to decomposition of the fluorocarbon or release of fluorocarbon gases. For example, a coating including PTFE should preferably be used at a temperature under 750° F., more preferably under 500° F., to prevent decomposition of the PTFE and release of toxic tetrafluoroethylene gas.

In an example, the coating comprises titanium dioxide; PTFE, such as Teflon® manufactured by DuPont or SST™ series of products manufactured by Shamrock Technologies, Inc.; and a polymer formed from an alkyd resin.

In a further example, the coating comprises PTFE in an amount at least about 1%, preferably at least about 3%, more preferably at least about 5%, and most preferably at least about 7%, by weight of the wet coating. The coating comprises PTFE in an amount at most about 30%, preferably at most about 25%, more preferably at most about 20%, and most preferably at most about 15% by weight of the wet coating. The coating comprises titanium dioxide in an amount at least about 1%, preferably at least about 2%, more preferably at least about 3%, and most preferably at least about 5%, by weight of the wet coating. The coating comprises titanium dioxide in an amount at most about 30%, preferably at most about 25%, more preferably at most about 20%, and most preferably at most about 10%, by weight of the wet coating. By weight of the dried coating, the coating comprises PTFE in an amount at least about 3%, preferably at least about 5%, more preferably at least about 7%, and most preferably at least about 10%. The coating comprises PTFE in an amount at most about 50%, preferably at most about 35%, more preferably at most about 30%, and most preferably at most about 20%, by weight of the dried coating. The coating comprises titanium dioxide in an amount at least about 1%, preferably at least about 2%, more preferably at least about 3%, and most preferably at least about 5%, by weight of the dried coating. The coating comprises titanium dioxide in an amount at most about 30%, preferably at most about 25%, more preferably at most about 20%, and most preferably at most about 15%, by weight of the dried coating.

In an example, the coating comprises, by weight of the dried coating, an alkyd resin polymer in an amount of about 20 to 60%, PTFE in an amount of about 1 to 50%, and titanium dioxide in an amount of about 1 to 30%. In another example, the coating comprises, by weight of the dried coating, an alkyd resin polymer in an amount of about 30 to 50%, PTFE in an amount of about 7 to 15%, and titanium dioxide in an amount of about 5 to 15%.

Titanium dioxide advantageously provides high heat resistance and tolerance and, preferably alone or in combination with PTFE, is sufficient to reduce or prevent thermal adhesion and facilitate removal of material adhered to the coating. Titanium dioxide and PTFE are preferably provided in amounts individually, and optionally in combination, to impart anti-stick or anti-thermal adhesion characteristics to significantly reduce thermal adhesion to the coating and to facilitate removal of adhered material from the coating. Also, the individual or combined amounts of the titanium dioxide and PTFE are preferably sufficient to reduce or substantially prevent the material adhered by thermal adhesion from coalescing or melding with the coating.

A suitable solvent, such as water, acetone, xylene, methyl ethyl ketone (MEK), or a mixture thereof, is included as a liquid carrier for preparing the coating in liquid form. The solvent is included in an amount sufficient to wet out the resin and to keep a pigment in suspension, about 15 to 70% by weight of the liquid composition. The solvent is evaporated during the coating process, and is not present in the final dried coating, except for trace amounts.

The coating composition can additionally include one or more additives, including a catalyst for accelerating the curing process; a surfactant; a filler, e.g., talc; a thickener; a suspension agent, e.g., alginic acid salt; a dispersing agent, e.g., hydrous sodium polysilicate; an anti-stick agent such as ceramic, wax, e.g., polyethyerene wax, and minerals having little or no affinity for weld spatter adhesion, e.g., aluminum tri-hydroxide, graphite, hexagonal boron nitride, aluminosilicate, and calcium carbonate; a foam control agent or deaerator; an anti-corrosion agent, e.g., zinc phosphate; an anti-bacterial or anti-fungal agent; a fire or smoke retardant, e.g., aluminum tri-hydroxide; a freeze preventing agent, e.g., ethylene glycol, propylene glycol, glycerin, MP-Diol; an anti-skinning agent, e.g., ethylene glycol, propylene glycol, glycerin, MP-Diol; and a pigment. When a wax is used, the wax imparts a slippery property that further helps resist weld spatter from sticking to the coating and facilitates removal of weld spatter. Additives are included in an amount effective to provide the desired characteristic to the coating, typically about 0.1 to 10% by weight of the liquid composition.

In an example, the liquid coating composition comprises, by weight, about 30 to 70% of a solvent; about 10 to 50% of an alkyd resin; about 1 to 15% of a cross-linking agent; about 1 to 30% of titanium dioxide; about 1 to 10% of talc; and about 0.1 to 5% of each additional additive. In a further example, the liquid coating composition comprises, by weight, about 30 to 60% of a solvent; about 10 to 40% of an alkyd resin; about 1 to 15% of a cross-linking agent; about 1 to 20% of titanium dioxide; about 1 to 5% of talc; and about 0.1 to 3% of each additional additive. PTFE can additionally be included in an amount of about 1 to 30%, if desired.

The coating 60 is applied by any suitable coating method, including dipping, spraying, and brushing. For example, the tip 36 and the nozzle 50 can be dipped into a pool of liquid coating material, or liquid coating can be sprayed or brushed on the exterior surface of the tip 36 and the exterior and interior surfaces of the nozzle 50. The coating can be applied in one application or in multiple applications to achieve the desired coating thickness or specification.

The thickness and amount of coating is adjusted depending on the size and configuration of the coated device and its intended use.

According to one embodiment, the coating is applied in one or more layers by dipping the nozzle and/or tip in liquid coating material, flashing off the solvent, and cross-linking the polymer to solidify the coating. The flashing off of the solvent and the cross-linking are typically achieved or assisted by heating, such as by baking.

In an example, a first coating is applied at about 50 to 100° F. by dipping the nozzle or tip into the liquid coating composition. The coated device is then heated at about 100 to 250° F. for a sufficient time to flash the solvent. These dipping and flashing steps can be repeated as needed. After the desired amount of coating has been applied, and the solvent flashed, the coated device is heated sufficiently to cross-link the polymer resin, such as at about 200 to 600° F. for several minutes. Additional heating and cooling cycles can be employed as needed.

The coating according to the invention provides superior protection against adhesion and accumulation of weld spatter, including those containing mild steel or galvanized steel commonly used as workpiece in MIG welding, as well as other thermal adhesion.

When using traditional uncoated MIG nozzle assemblies, the welding process must be frequently interrupted to disconnect the traditional nozzle assembly to remove the spatter, which typically requires filing, and the nozzle should be reamed every so often, which can be as little as after about three welds. Remarkably, over at least 50, more preferably at least about 100, and most preferably at least about 150 or 200 welding operations can be performed continuously without interrupting the operation to remove weld spatter from the inventive coated nozzle, after which accumulated weld spatter can be dislodged and removed simply by light impact. In an embodiment, the nozzle can be used for at least about 5 hours, more preferably at least about 10 hours, and most preferably at least about 15 hours of continuous welding operations without interruption to remove weld spatter. After the weld spatter is removed, the nozzle can again be used in welding operations of similar duration. Further, after repetitive use, the nozzle can be sandblasted, in preparation for recoating, and recoated with the another layer of coating.

The coating therefore allows the welding tip and nozzle assembly to maintain an acceptable level of gas flow to the weld through multiples runs of welding operation, and reduces the likelihood of producing a defective weld. By inhibiting spatter adhesion, the coating also reduces incidents of burn back, thereby reducing the likelihood of premature tip replacement.

The inventive coating greatly simplifies and facilitates removal of weld spatter sine it significantly decreases the strength of the adhesion of the spatter to the coated nozzle assembly. Cleaning of the coated device is facilitated, and the coating enables simplified and less frequent reconditioning, as well as reusability of the device. The coating has been found to enable removal of weld spatter from the coated device simply by light impact, without requiring abrasive or cutting tools, such as files and reamers, which are required for removing spatter from existing coated and uncoated nozzles. In particular, the coated nozzle according to the invention can be tapped, such as taps by hand, to cause the weld spatter to fall freely from the nozzle. In an example, at least about 10% of weld spatter adhered to the coating is removable by tapping. More preferably, at least about 50% of weld spatter adhered to the coating is removable by tapping. Most preferably, at least about 90% of weld spatter adhered to the coating is removable by tapping.

The preferred coated nozzle assembly does not have to be cleaned more thoroughly of spatter than by tapping than after at least 50 welding operations, more preferably at least 100 operations, and most preferably after at least 150 or 200 operations, while retaining an acceptably gas flow. After repeated use and cleaning, any remaining spatter can be removed, preferably substantially all of the remaining spatter, and the nozzle can be sandblasted and recoated.

Thus, the coating not only simplifies the cleaning procedure, but allows significantly longer welding operations to be performed without cleaning. In one embodiment, the coated nozzle assembly is operated without cleaning for about eight times longer than an uncoated nozzle assembly. For example, where a traditional uncoated MIG nozzle is cleaned by filing or reaming the nozzle after every half hour of operation, the coated nozzle according to the invention can be operated for four hours before cleaning, e.g., by tapping the nozzle to remove weld spatter.

The coating is preferably prepared to act as an effective thermal barrier against heat, thereby preventing thermal damages, including metal burn, discoloration or distortion commonly observed in metal welding nozzles, improving the longevity of welding nozzles and tips, and significantly inhibiting and reducing weld spatter from sticking to the coated portions due to the elevated temperature thereof, such as by coalescing with the metal of the nozzle assembly. Because of its thermoprotective properties, the coating is also useful as a thermal barrier on products used in high heat environment or operation, such as weld fixtures, clamps used to hold workpiece during welding, and base tables for plasma or laser operation.

It will be appreciated that the coating of the invention can be applied in combination with a coating enhancer or a coating having a different composition and properties. For example, a coating primer can be provided under the coating as a base coat, or a top coat can be applied over the coating. A layer of a different but compatible coating composition can be provided over or under the present coating to further supplement performance of the coating of the invention. For example, a coating of PTFE and/or titanium dioxide can be applied in combination with the present coating to provide additional anti-stick or heat-resistance properties. The above description and the following examples are illustrative only and are not restrictive or limiting.

### EXAMPLES

### Example 1

### The Preparation and Performance of the Coated Nozzle

A nozzle and a tip were coated with a coating containing titanium dioxide according to the invention. The nozzle was a typical copper nozzle used in a MIG weld gun, manufactured by Tweeco, Part Number 24A-62 and weighing 83.36 grams. The opening of the tip was plugged to prevent coating of the inner diameter of the tip.

The coating was applied on the nozzle and the tip and cured. A total of about 870 mg of liquid composition was applied, and the weight of the dried and cured coating was about 670 mg.

The coated nozzle was tested in a continuous, MIG welding operation, at 190 Amps and 220 Volt. Mild steel workpiece was used to form medium welds having ⅜ inch weld bead. The operation was continued until the nozzle showed physical signs of failure. “Failure,” as used herein, means excessive weld spatter build-up on the coated nozzle, as shown by physical indicators such as the quality of the weld, restriction on nozzle opening, and flow of the gas. The coated nozzle showed almost no spatter build-up for the first minute. For the next 25 to 30 minutes, the nozzle maintained a high level of performance, with insignificant amount of spatter build-up. The weight of spatter on the nozzle after 25 minutes of continuous welding operation was about 1.175 g. After another hour of continuous welding operation, the total weight of spatter on the nozzle measured at 1.82 g. After about 10.5 hours of operation, the nozzle still maintained an acceptable level of gas flow and produced welds of acceptable quality. At 16.25 hours of operation, the nozzle showed signs of failure and produced welds of poor quality.

When the nozzle was cleaned after 40 minutes of welding, by slightly tapping the welding gun on the table, the weld spatter accumulated on the nozzle freely fell off in one piece. When cleaned after another 35 minutes of welding by slight tapping, the weld spatter freely fell off in two pieces. The coating was in good condition after each cleaning.

As used herein, the term “about” should generally be understood to refer to both the corresponding number and a range of numbers. Moreover, all numerical ranges herein should be understood to include each whole integer within the range. While illustrative embodiments of the invention are disclosed herein, it will be appreciated that numerous modifications and other embodiments may be devised by those skilled in the art. For example, the features for the various embodiments can be used in other embodiments. Therefore, it will be understood that the appended claims are intended to cover all such modifications and embodiments that come within the spirit and scope of the present invention.

What is claimed is:

1. A welding aid for use with a high-temperature exposure article configured for exposure to a predetermined temperature comprising a particulate titanium dioxide weld spatter adhesion inhibitor and a liquid carrier for the adhesion inhibitor, whereby the mixture of the adhesion inhibitor and the liquid carrier is capable of being applied as a coating upon a surface of the article to form a thermal barrier that inhibits adhesion of weld spatter to the article.

2. The welding aid of claim 1, which further comprises a cross-linking polymer in an amount sufficient to provide cross-linking during formation of the thermal barrier.

3. The welding aid of claim 2, wherein the coating comprises the titanium dioxide in an amount of 1 to 30% by weight of the coating.

4. The welding aid of claim 3, wherein the carrier comprises about 15 to 70% by weight of a solvent and about 10 to 50% by weight of an alkyd resin and the cross-linking agent is present in an amount of about 1 to 15% by weight.

5. The welding aid of claim 1, further comprising a particulate fluorocarbon adjuvant mixed with the inhibitor.

6. A method for protecting a high-temperature exposure article from weld spatter adhering thereto, which comprises applying the welding aid according to claim 1 as a coating upon at least a portion of a surface of the article prior to welding so that weld spatter does not adhere to the article surface to facilitate removal therefrom.

7. The method of claim 6, wherein the article is a welding nozzle and the coating is applied to a surface of the nozzle susceptible to receiving weld spatter.

8. A method for improving longevity of a welding nozzle, which comprises applying the welding aid according to claim 1 as a coating upon at least a portion of a surface of the nozzle susceptible to receiving weld spatter to form a thermal barrier thereon to reduce the adherence of weld spatter thereto.

9. A coated welding assembly, comprising:
a nozzle assembly configured for heating a workpiece to a temperature sufficient to weld the workpiece; and
a thermal barrier provided upon at least a portion of a surface of the nozzle, the thermal barrier comprising a titanium dioxide weld spatter adhesion inhibitor so that the thermal barrier inhibits adhesion of weld spatter to the nozzle assembly.

10. The coated welding assembly of claim 9, wherein the thermal barrier comprises titanium dioxide in an amount of 1 to 30%, by weight.

11. The coated welding assembly of claim 9, wherein the nozzle assembly comprises a gas nozzle configured for connecting to a source of gas to conduct a welding operation and for discharging the gas to a workpiece for welding the workpiece, wherein the thermal barrier is provided upon at least a portion of the gas nozzle.

12. The coated welding assembly of claim 11, wherein the thermal barrier is provided upon at least a portion of the interior and exterior surfaces of the gas nozzle.

13. The coated welding assembly of claim 12, wherein the thermal barrier is provided upon the entire inner surface and a predetermined portion of the exterior surface of the gas nozzle.

14. The coated welding assembly of claim 11, wherein the nozzle assembly comprises a tip portion configured for connecting to a welding gun and for feeding a welding rod to a workpiece for welding the workpiece, wherein the thermal barrier is provided upon the tip to reduce accumulation of weld spatter on the tip.

15. The coated welding assembly of claim 9, wherein the nozzle assembly comprises a tip portion configured for connecting to a welding gun and for feeding a rod of welding material to a workpiece for welding the workpiece, wherein the thermal barrier is provided upon the tip to reduce accumulation of weld spatter on the tip.

16. The coated welding assembly of claim 15, wherein the thermal barrier is provided upon an exterior surface of the tip and an interior surface of the tip in sliding contact with the rod is substantially free of the thermal barrier.

17. The coated welding assembly of claim 15, wherein the nozzle assembly is configured for MIG welding and the tip is configured for feeding a consumable welding rod.

18. The coated welding assembly of claim 9, wherein the thermal barrier provides resistance to adhesion and accumulation of weld spatter for at least 5, 10, or 15 hours of continuous welding operation, such that at least 10% of the spatter adhered to the coating is removable by tapping by hand.

19. The coated welding assembly of claim 9, wherein the thermal barrier provides resistance to adhesion and accumulation of weld spatter for at least 5, 10, or 15 hours of continuous welding operation, such that at least at least 50% of the spatter adhered to the coating is removable by tapping by hand.

20. A method for preparing the coated welding assembly of claim 9, which comprises preparing a liquid coating composition comprising, by weight of the liquid composition, about to 70% of a solvent, about 10 to 50% of an alkyd resin, about 1 to 15% of a cross-linking agent, and about 1 to 30% of titanium dioxide; dipping a portion of the nozzle assembly into the composition to form a coating thereon; and drying and curing the composition to form the thermal barrier on that portion of the nozzle assembly.

21. A welding nozzle for a welding gun comprising a nozzle adapted to substantially surround a welding tip of the welding gun and having an interior surface operatively disposed adjacent the welding tip and an exterior surface opposite said interior surface, at least a portion of the interior and exterior surfaces of the nozzle having a thermal barrier disposed thereon, wherein the thermal barrier comprises a titanium dioxide weld spatter adhesion inhibitor so that the thermal barrier inhibits adhesion of weld spatter to the nozzle.

22. The welding nozzle of claim 21, wherein the nozzle comprises copper and wherein the thermal barrier comprises titanium dioxide in an amount of about 1 to 30%, by weight.

23. A method for removing weld spatter adhered to the welding nozzle of claim 22, which comprises exerting an impact force sufficient to dislodge the weld spatter from the nozzle.

24. The method of claim 23, which further comprises recoating the nozzle after removing weld spatter therefrom.
